(19) United States
(12) Patent Application Publication
(10) Pub. No.: US 2010/0084410 A1
(43) Pub. Date: Apr. 8, 2010

(54) THERMAL PACKING CONTAINER

(76) Inventor: Tuan Tran, Cerritos, CA (US)

Correspondence Address: IRELL & MANELLA LLP, 1800 AVENUE OF THE STARS, SUITE 900, LOS ANGELES, CA, 90067, US

(21) Appl. No.: 12/572,050

(22) Filed: Oct. 1, 2009

Related U.S. Application Data
(60) Provisional application No. 61/102,245, filed on Oct. 2, 2008.

(51) Int. Cl. B65D 81/38; B31B 1/00; B32B 3/28

(52) U.S. Cl. 220/592.2; 493/110; 428/182; 428/186

(57) ABSTRACT

A thermal packing container that includes a plurality of walls formed from a single composite individual sheet. The composite sheet includes a corrugated substrate, a metalized barrier and an outer foam layer. The composite sheet can be transported in flat configuration and then formed into a container at a packing facility. The packing container is relatively impervious to fluids and has a high thermal impedance that minimizes heat flow into the contents of the container. The thermal packing container can be used to transport food items from the packing facility.

### CROSS-REFERENCE TO RELATED APPLICATIONS

This application claims priority to Application No. 61/102,245, filed on Oct. 2, 2008.

### BACKGROUND OF THE INVENTION

1. Field of the Invention

The present invention relates to a packing container for packing items such as food.

2. Prior Art

Temperature sensitive goods such as food items are typically packed into containers before shipping. The containers should have a relatively high thermal resistance to minimize the flow of heat into the food items. Heat can cause the food to spoil.

One common type of food packing container is a Styrofoam box. Styrofoam boxes are constructed in a fully formed position creating a package that is bulky to handle and store. Cardboard boxes can be stored in a flat position but are susceptible to leaking and lose tensile strength in a wet condition. It is therefore desirable to provide a packing container that is thermally resistant, impervious to liquid, can be stored in a flat position, and manufactured in a cost effective manner.

### BRIEF SUMMARY OF THE INVENTION

A thermal packing container that includes a plurality of walls formed from a single composite individual sheet. The composite sheet includes a corrugated substrate, a metalized barrier and an outer foam layer.

### BRIEF DESCRIPTION OF THE DRAWINGS

FIG. 1 is a perspective view of a thermal packing container;

FIG. 2 is an exploded view of a composite sheet used to form the thermal packing container; and,

FIG. 3 is an illustration of a process for manufacturing the thermal packing container.

### DETAILED DESCRIPTION

Disclosed is a thermal packing container that includes a plurality of walls formed from a single composite individual sheet. The composite sheet includes a corrugated substrate, a metalized barrier and an outer foam layer. The composite sheet can be transported in flat configuration and then formed into a container at a packing facility. The packing container is relatively impervious to fluids and has a high thermal impedance that minimizes heat flow into the contents of the container.

The thermal packing container can be used to transport food items from the packing facility.

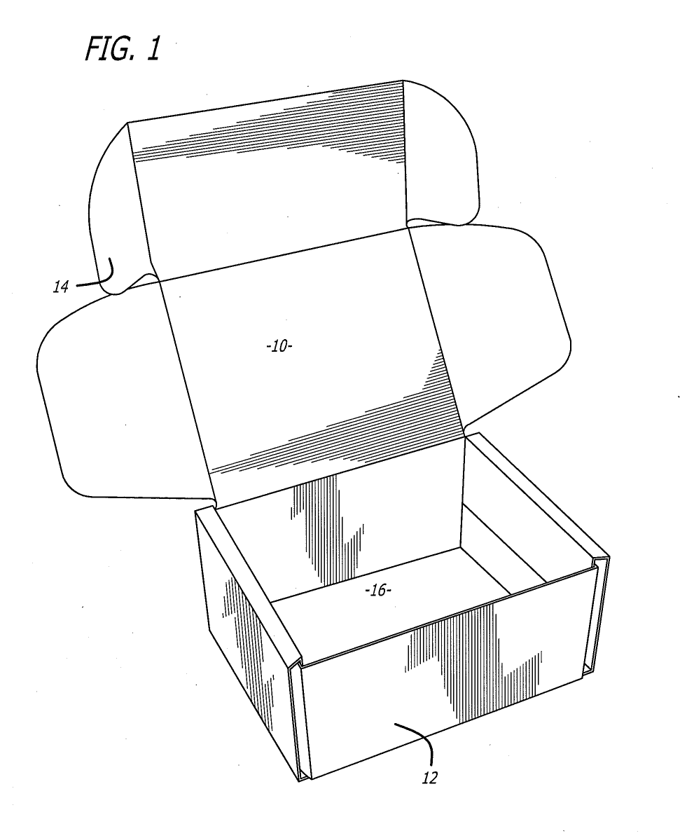

FIG. 1 shows an embodiment of a thermal packing container 10 of the present invention. The packing container 10 includes a plurality of walls 12 that are formed from a single composite individual sheet 14. The container 10 may include an inner compartment 16 that can store items such as food (not shown). Ice or other coolant material may also be placed into the inner compartment 16 to maintain the temperature of the food below a desired temperature. The container 10 can be formed from the sheet 14 with known box folding techniques.

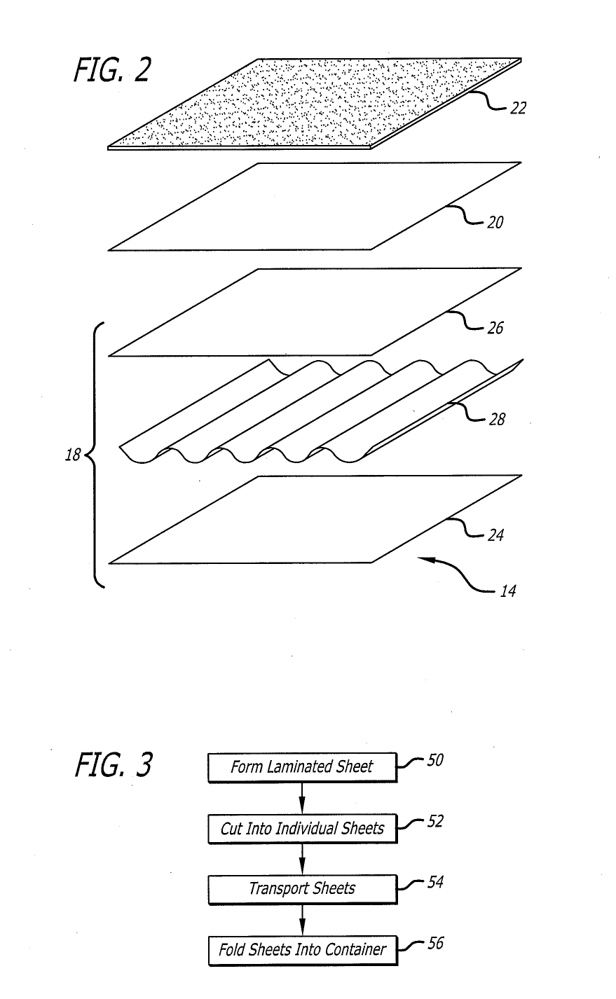

FIG. 2 shows an embodiment of a composite sheet 14 that is used to form the thermal packing container 10. The sheet 14 has three primary layers, a corrugated substrate 18, a metalized barrier 20 and an outer foam layer 22. The corrugated substrate 18 can be constructed from two corrugated liners 24 and 26 that sandwich a corrugated medium 28. The barrier 20 can be a metalized polyester. For example, the metalized polyester barrier can be a 48 gauge metalized polyeseter/.001 PE. The foam layer 22 can be constructed from a polyethelene foam.

The metalized barrier 20 can be laminated to the corrugated substrate 18 by an adhesive (not shown). The adhesive may be a commercially available MSDS V-70 product. The barrier 20 may also be laminated to the foam layer 22. The barrier 20 may also be laminated to the foam layer 22 by the MSDS V-70 adhesive.

FIG. 3 shows a process for creating the thermal packing container 10. A large laminated sheet is formed in process step 50. The laminated sheet is created by laminating together the corrugated substrate 18, barrier 20 and outer foam 22. In process step 52 the large sheet is cut into a plurality of individual sheets. The large sheet can be cut into desired shapes with conventional die cutting equipment. The formation and cutting of the composite sheets is typically performed at a first facility. By way of example, the first facility may include lamination, die cutting and gluing equipment used to create the individual sheets.

In process step 54 the individual composite sheets can be transported to a second facility. The sheets can be transported in a stacked arrangement to minimize space. The sheets can also be stored at the second facility in a flat position. This minimizes the inventory space required to store the sheets. In process step 56 the individual sheets are folded into packing containers. By way of example, the second facility may be a food packing plant. The individual sheets are folded into packing containers, food is placed into the container and then shipped from the facility.

The metal barrier 20 and outer foam 22 create an outer shell that is impervious to liquid and has a relatively high thermal impedance. The corrugated substrate 18 provides structural integrity while allowing the sheet to be folded from a flat position. The result is a packing container that can store temperature sensitive goods in a manner that minimizes heat flow, prevents liquid damage, can be stored in a flat position, and can be constructed using conventional die cutting equipment.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A thermal packing container, comprising:
a plurality of walls formed from a single composite individual sheet that includes a corrugated substrate, a metalized barrier and an outer foam layer.

2. The thermal packing container of claim 1, wherein said metalized barrier is laminated to said corrugated substrate with an adhesive.

3. The thermal packing container of claim 1, wherein said outer foam layer is laminated to said metalized barrier with an adhesive.

4. The thermal packing container of claim 1, wherein said corrugated substrate includes a pair of corrugated liners attached to a corrugated medium.

5. A composite sheet used to form a thermal packing container, comprising:
a corrugated substrate;
a metalized barrier attached to said corrugated substrate; and,
an outer foam layer attached to said metalized barrier.

6. The wall of claim 5, wherein said metalized barrier is laminated to said corrugated substrate with an adhesive.

7. The wall of claim 5, wherein said outer foam layer is laminated to said metalized barrier with an adhesive.

8. The wall of claim 5, wherein said corrugated substrate includes a pair of corrugated liners attached to a corrugated medium.

9. A process for creating a thermal packing container, comprising:
forming a composite sheet that includes a corrugated substrate, a metalized barrier and an outer foam layer;
cutting the composite sheet into a plurality of single composite individual sheets at a first facility;
transporting the plurality of single composite individual sheets to a second facility; and,
forming a plurality of thermal packing containers from the single composite individual sheets at the second facility.

10. The method of claim 9, wherein the composite sheet is formed by laminating the metalized barrier to the corrugated substrate and laminating the outer foam layer to the metalized barrier.

11. The method of claim 9, wherein the composite sheet is cut with a die cutting machine.

12. The method of claim 9, wherein the individual pieces are transported in a stacked arrangement.
